(19) United States
(12) Patent Application Publication
(10) Pub. No.: US 2020/0296931 A1
(43) Pub. Date: Sep. 24, 2020

(54) Pet Toy

(71) Applicant: Elizabeth Bentz, Denver, CO (US)

(72) Inventor: Elizabeth Bentz, Denver, CO (US)

(21) Appl. No.: 16/360,873

(22) Filed: Mar. 21, 2019

(51) Int. Cl. A01K 15/02

(52) U.S. Cl. CPC A01K 15/025

(57) ABSTRACT

The invention is a pet toy that has a plush body with small apertures through which a strand of fabric that has individual squeakers of differing tones sewn into individual segments of the fabric strand, and where the apertures are made small enough in the toy body to depress the squeakers as the strand is tugged through. The toy can be played with by a pet alone or has a nylon looped rope handhold that a pet owner or the pet can hold and play tug-of-war while causing multiple squeakers to make noise during the tugging movements or when a pet depresses portions of the toy.

### FIELD

The present invention relates generally to stimulating, encouraging and motivating games and methods of playing regarding pets, e.g. dogs and cats. More particularly, the invention relates to motivational games, toys and methods for assessing the pet training skills in the form of games or puzzles that incite pet interaction and memory skills.

### PRIOR ART

There are many types of pet toys on the market that squeak or that can be used in a tug-of-war game between an owner and a dog, or multiple dogs without their owner's interaction. This novel toy is designed to provide pets of all sizes an appealing interaction with the toy and production of several distinct sounds.

### BRIEF DESCRIPTION OF THE INVENTION

The novel design of the inventive toy allows a pet owner to hold a section of intertwined rope that forms a loop and is sewn within the body of the toy, and offer multiple sections of the toy (considered legs or arms) to the pet to pull through apertures in the toy body wherein multiple individually sewn squeakers are compressed as the appendage is pulled through the toy body and each individually sewn “bubble” will make varying tones of squeaking sounds.

The object of the present invention is to motivate and maintain interest of a pet. The act of pulling an appendage of the toy allows it so to slide through an aperture in the toy body that causes each squeaker bubble to depress as it's drawn through the aperture thus creating a squeaking sound. Each squeaker bubble creates a different tone of squeaking sounds.

The toys are configured to represent different animal or character shapes wherein the outer portion is a plush material that creates a head, body, legs, arms, etc. Both of the arms and legs may be pulled through apertures in the toy body to cerate the multiple squeaking sounds. A further embodiment of the toys can have a squeaker located inside the head of the plush toy animal or the belly, or both.

### BACKGROUND OF THE INVENTION

The invention most closely corresponds with USPTO Class 119/707 wherein Class 119 relates to animal husbandry and sub-class 707 includes toys.

In its simplest form, the invention relates to a novel toy for pets wherein a pet can play with the toy by itself, or play a “tug of war” game with a pet owner wherein the pet owner holds a looped section of rope and offers either arms or legs to the pet to tug on and cause the appendage to pull through the apertures in the toy body and cause the squeaker bubbles to create varying squeak tones.

### THE INVENTION

### Summary, Objects and Advantages

It well known that pets do experience a sense of boredom, and if not addressed, may manifest in negative behavior such as chewing furniture or going to the bathroom in undesirable locations in the pet owner's home. The inventive toy is designed to capture and retain a pet's interest whether the pet owner is away or home. The pet owner can manipulate the toy in some way to actively play with the pet as well. The toy is not designed to “replace” human interaction, but rather to help keep a pet entertained even if the owner is not also interacting with the toy and pet.

### BRIEF DESCRIPTION OF THE DRAWINGS

The invention is described in further detail by reference to nine (9) drawings sufficient in detail to describe the invention in which:

FIG. 1 is an illustration a penguin version of the toy with the pull-through arms;

FIG. 2 is an internal view of the penguin toy showing location and style of squeakers;

FIG. 3 is an illustration without internal workings shown;

FIG. 4 is an example of the toy with alternate plush casing and arms;

FIG. 5 is the alternate plush casing showing internal workings of the toy;

FIG. 6 shows the toy without internal workings;

FIG. 7 is an embodiment sans rope loop but the toy arms are illustrated;

FIG. 8 illustrates the cherry embodiment with both internal and external design is shown; and

FIG. 9 illustrates the cherry embodiment externally only.

### DETAILED DESCRIPTION, INCLUDING BEST MODES OF CARRYING OUT THE INVENTION

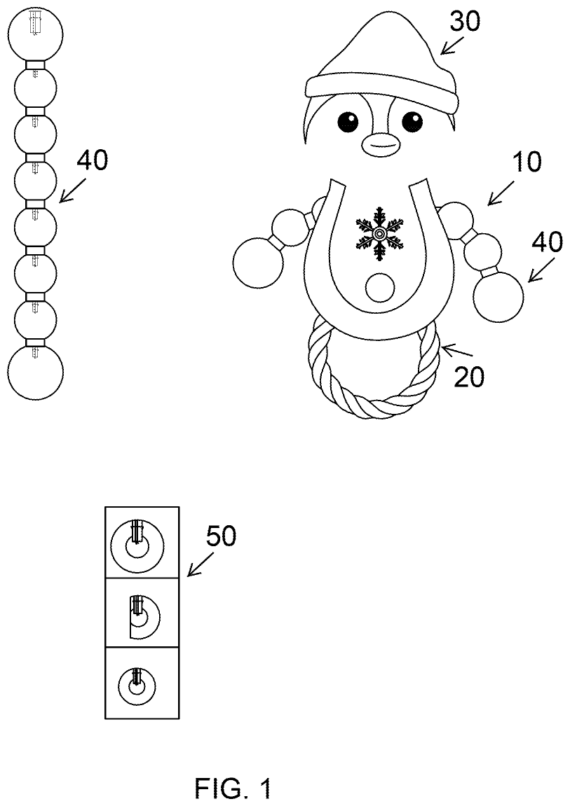

FIG. 1 shows the plush body of the penguin toy embodiment 10. A looped rope half circle 20 extends from the head 30 of the toy for pet or pet owner grasping. The head 30 of the toy may contain a squeaker. The “arms” of the toy 40 contain individually sewn squeaker “bubbles” which traverse the entire length of the arm piece in close position to one another. When this arm is pulled though an aperture that runs through the plush body, each squeaker bubble is compressed and creates a squeaking sound. Each squeaker in the arm creates different squeak tones. The squeaker bubbles in the arm are large enough so as to prevent the entire arm pulling out of the toy. The arm will only move back and forth within the plush body aperture. Within the arms are reed toned squeakers 50 with stitching such that the squeakers will not move within the toy's arm.

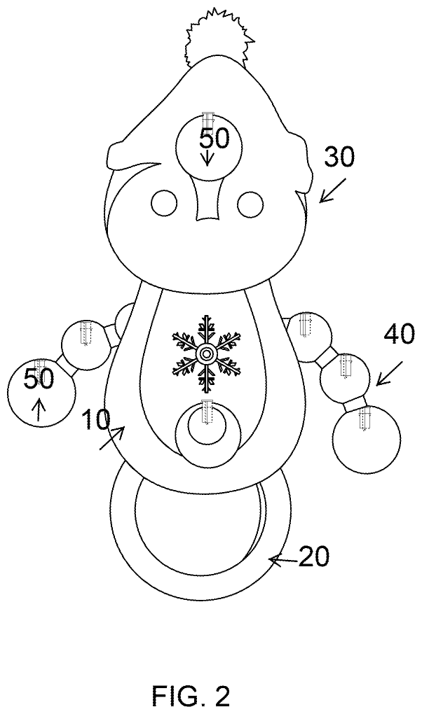

FIG. 2 is a cutaway of the penguin toy showing again the head 30 portion and a squeaker 50 as may reside within the body 10 and rope loop 20 are again illustrated. The arm with squeaker bubbles 40 is shown separate for clarity. Again, the arm will pull from side to side within the toy body but will not be pulled completely out of the body due to large squeaker bubbles on the tips of the arms which will not traverse through the aperture in the body.

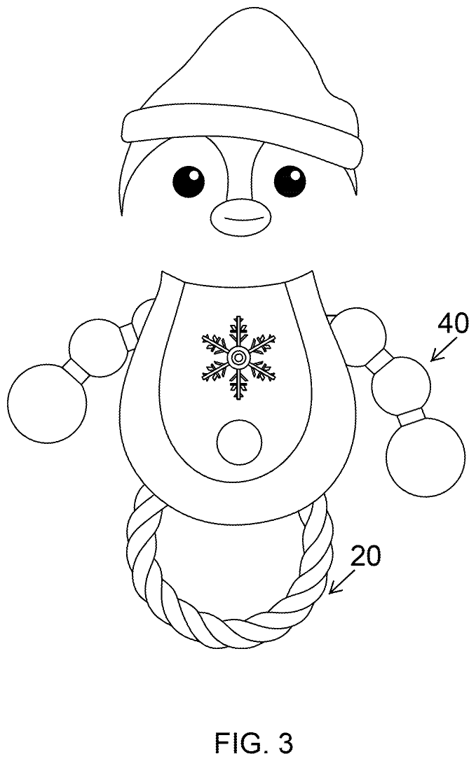

FIG. 3 is an illustration of the penguin toy external view. The squeaker bubble arm 40 is shown as inserted and the looped rope 20 as affixed to the body.

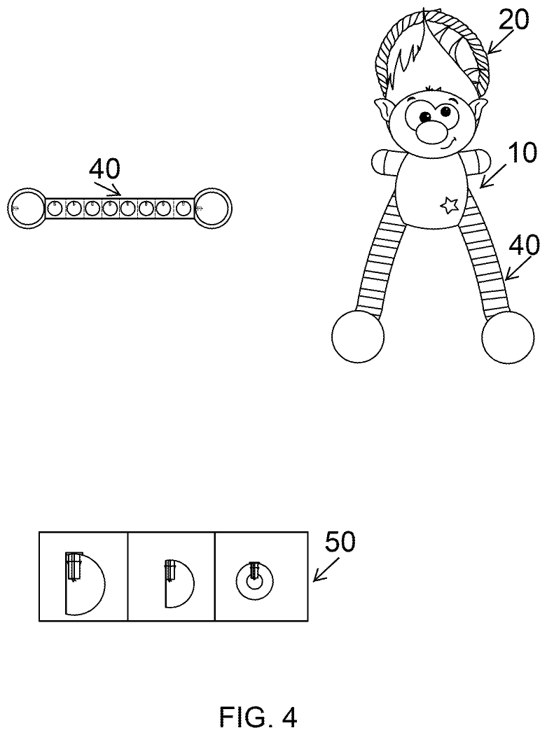

FIG. 4 is another embodiment of the toy with a different plush figure, here an elf or troll. Again, a plush body 10 has a looped rope portion 20 sewn to one end of the toy (here the head). As with the other plush figures, this version uses squeaker bubbles as legs 40, and which contain individual squeakers sewn into the leg that will make various squeaking sounds as the legs are pulled through the aperture in the plush body. As seen, the squeakers at the end of the legs are too large to travel all the way through the body and thus will remain attached to the toy. Again, reed squeakers 50 are shown in cutout for clarity.

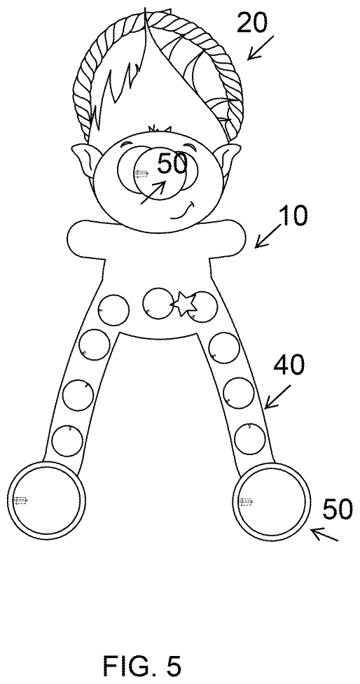

FIG. 5 illustrates the elf or troll toy in cutaway to demonstrate the squeaker bubble legs 40 as they travel though an aperture in the plush body, causing compression and squeaking sounds as it is pulled by a pet or pet owner. A looped rope 20 portion is attached to the head, and a squeaker 50 may be placed inside the head of the toy as well at the end of the feet of the toy. The same basic function occurs in the toy embodiments whether the squeaker bubble portions be “legs” or “arms”.

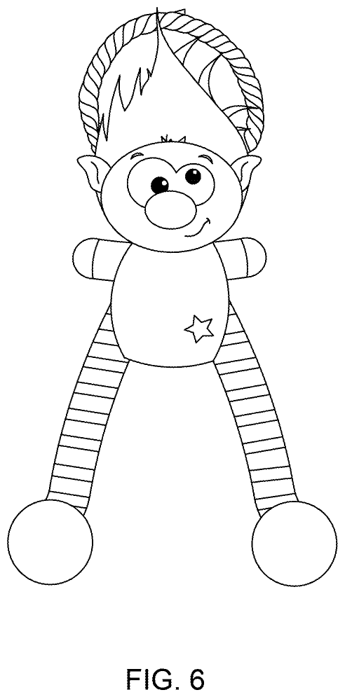

FIG. 6 shows the elf or troll toy external view only. The previous FIG. detailed the internal workings of the toy in this FIG.

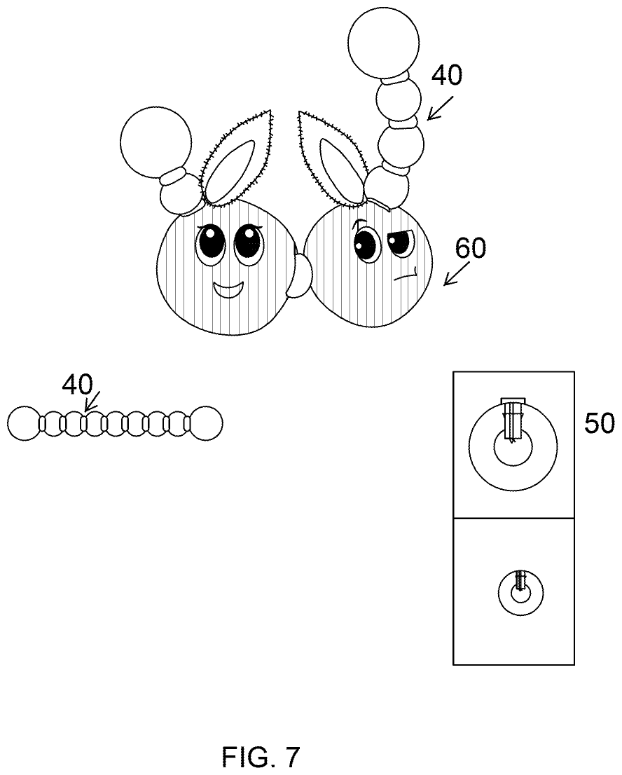

FIG. 7 is another embodiment wherein the plush body is in the shape of two cherries 60, and wherein a length of individually sewn in squeakers create the length of squeaker bubbles to be pulled similarly through an aperture in the plush body as with the previous embodiments. This version of the toy may not have a loop of rope attached to the plush body. Reed squeakers 50 are shown in inset for clarity. There may be a squeaker placed within each cherry.

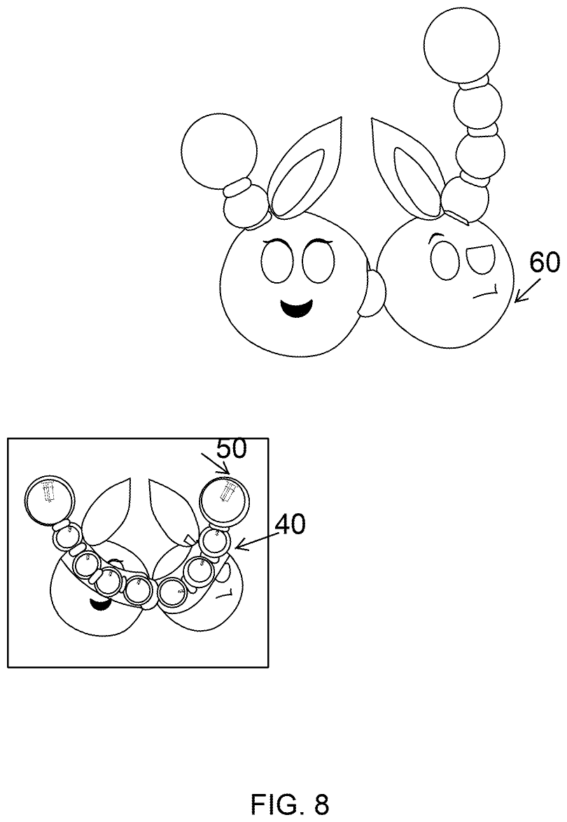

FIG. 8 illustrates the cherry toy's external 60 and internal views. The length of squeaker bubbles 40 are shown internally to illustrate the basic pulling operation through an aperture in the cherry plush body, and again, the ends may have squeaks 50 and are designed so that the length of squeaker bubble will not pull out of the toy.

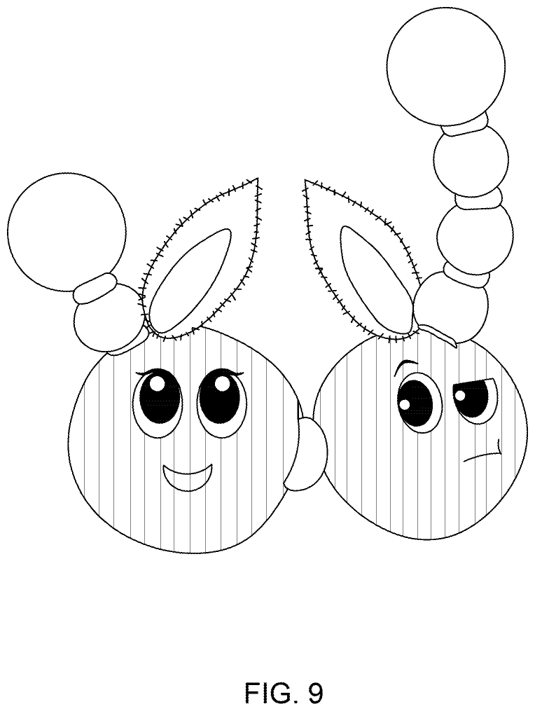

FIG. 9 is a clean version of the cherry toy as the user will see it externally.

1) A pet toy comprising:
a) A plush fabric outer body in the shape of an animal or other character depiction;
b) A fabric strand wherein squeakers are sewn into individual segments of fabric so as to be fixed within each segment and where the strand forms arms or legs of a depicted shape, and are moveable within apertures in the plush outer body created small enough to cause compression of the squeakers as they travel through the apertures;
c) Varying toned squeakers enclosed within the individual segments of fabric;
d) A loop of nylon rope forming a hand-hold for a pet or user wherein the rope is sewn with an inside stitch pattern and serves as a hand-hold for pulling; and
e) A head or main segment of outer plush fabric wherein the head or body cavity contain squeakers and restricted to within a segment.

2) A pet toy as in claim 1 wherein the outer body of the toy is a plush fabric and has apertures through which a fabric strand containing squeakers sewn into individual segments of fabric so as to be fixed within each segment may travel when either end is pulled on by a user or pet, and where the strand forms arms or legs of a depicted shape.

3) A pet toy as in claim 1 wherein the fabric strand of squeakers is moveable through the apertures in the plush body and in being pulled therethrough causes the strand to travel through the apertures in the toy body and be depressed as a result of traveling through apertures small enough to compress the squeakers.

4) A pet toy as in claim 1 wherein each squeaker located in a segment of the fabric strands creates a different tone than the others.

6) A pet toy as in claim 1 wherein a loop of nylon rope may be affixed to a portion of the toy and sewn using inside seams for strength and which allow either a pet or a user to grasp and be able to pull the toy.

7) A pet toy as in claim 1 wherein the head or another shaped segment of the toy body may contain squeakers sewn into a segment so that the squeaker remains in that segment and will create sound when depressed.
